(19) United States
(12) Patent Application Publication
(10) Pub. No.: US 2007/0065560 A1
(43) Pub. Date: Mar. 22, 2007

(54) Method for modifying the texture of a dairy product

(75) Inventors: Siew Kim Lee, Palmerston North (NZ); Skelte Gerald Anema, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 10/563,314

(22) PCT Filed: Jul. 5, 2004
(86) PCT No.: PCT/NZ04/00142

§ 371 Date: Aug. 1, 2006

(30) Foreign Application Priority Data
Jul. 4, 2003 (NZ) 526878

(51) Int. Cl. A23C 19/00

(52) U.S. Cl. 426/582

(57) ABSTRACT

The invention provides a process for preparing cheese, a cheese-like product, a yoghurt or a dairy dessert without removing whey. It comprises providing a dairy starting material comprising casein and a quantity of undenatured (native) whey protein; adjusting the pH, if required, to a preselected point in the range 5.0-8.0; subjecting the material with the desired pH to a heating step; adjusting the pH of the heated intermediate product to 4.5-7.5 and processing and/or packaging the pH 4.5-7.5 product to form the final product. The process involves the manipulation of the texture of a dairy gel.

### TECHNICAL FIELD

The present invention relates to processes for preparing dairy products and products produced. The processes involve manipulation of the texture of dairy gels using whey protein and adjustment of pH.

### BACKGROUND

A longstanding problem with the production of cheese and cheese-like products, including processed cheese is that the ability to vary the texture of the product is often relatively limited. This is particularly a problem where an all-dairy recipe is used or when a specified fat or protein content is required.

The texture of foods is a complex combination of science and art. The literature and art disclose many ways of manipulating the texture of cheese and cheese-like products. Texture in this context relates to instrumental/rheological methods used to determine stress-strain relationships at defined temperatures and deformation rates and fracture behaviour at defined temperatures and deformation rates. The texture of food products may also be evaluated by consumers or by using trained taste panellists by describing the mouth-feel attributes of the mastication process. The texture of foods may be manipulated over a wide range by a wide variety of methods, including but not limited to moisture content, fat content and composition, acidity, polymer structure, particle size, incorporation of multiple phases, shear rate and temperature.

Many manufacturers have adopted the practice of incorporating non-dairy ingredients into their products in an attempt to increase product firmness while reducing the protein content. The non-dairy ingredients most widely used in this role are gel-forming polysaccharides such as hydrocolloids and gums. This often necessitates labelling the products as “analogue” or “imitation” and the price has to be discounted to match consumer expectation.

In an attempt to manipulate textures of cheese-like products in all-dairy recipes a number of approaches have been used. These include manipulation of moisture, fat, incorporation of whey proteins, microparticulation, use of the enzyme transglutaminase, use of salts and pH variation.

U.S. Pat. No. 6,303,160 discloses a process whereby the texture of cream cheese was able to be significantly varied by controlling the incorporation of water at key stages of the manufacturing process.

U.S. Pat. No. 3,929,892 discloses a method whereby fat in cream cheese is replaced using a mixture incorporating heat denatured casein and whey proteins. The heat denaturated protein is mixed with cheese curd, acidified to attain the final pH required and then homogenised and packed. This process does not teach the in-situ denaturation at a controlled cooking pH of the protein. The process requires at least one homogenisation step and does not teach how to vary the texture by varying both cooking time and pH.

Various methods have been disclosed using ultrafiltration to concentrate milk to produce a variety of cheese and cheese-like products. The basis of these processes is to increase product yield by the incorporation of whey proteins. A distinguishing attribute of these processes is that the final whey protein/casein ratio is similar to that of the parent milk entering the ultrafiltration process. Such processes include those of U.S. Pat. Nos. 5,356,639 and 4,341,801. There is little scope to independently manipulate the texture of the product by varying the incorporation of whey protein to a desired level.

Alternative approaches include adding whey proteins to a cheese curd. U.S. Pat. No. 6,558,716 discloses a process that incorporates whey protein into cheese that is claimed to enhance functionality and reduce production costs. A cheese curd is produced by essentially conventional means. Whey protein (via a concentrate or powder) is added to the curd, then the mixture is homogenised and subject to heat treatment and shear. US Patent application 20020192348 discloses a process that attempts build on U.S. Pat. No. 6,558,716 by including the use of modified proteins, particularly modified whey protein ingredients in the preparation of processed cheese.

Another technique used for producing dairy-based gels of varying texture involves the controlled denaturing of soluble proteins, specifically the controlled denaturation of whey proteins (egg proteins may also be used). Distinguishing attributes of these processes are heat treatment, pH adjustment and homogenisation steps so that the protein particles emerge with a carefully controlled particle size distribution (typically <10 μm) i.e. micro particulation. See for instance EP patent application 1,201,134 and PCT published application WO 91/17665.

Löv & Löv (WO 98/08396) extend this process to the micro particulation of denatured casein-whey protein aggregates.

A further method of incorporating whey proteins into cheese and cheese-like products is to enzymatically crosslink the whey and casein proteins using an enzyme such as transglutaminase.

Processes where salt interactions are used include that of U.S. Pat. No. 4,166,142. This describes a method of preparing processed cheese where whey protein was denatured in conjunction with salts of phosphate and citrate along with the usual processed cheese ingredients including blends of young and old cheese.

NZ Patent 254127 discloses a process where salts of phosphate and citrate in conjunction with pH and heat modifies whey protein concentrate solutions, that are then dried and used as an ingredient in process cheese manufacture. The incorporated whey protein enables a significant reduction in cheese requirements in the process cheese formulation.

Modler & Emmons in International Dairy Journal 11, 517-523 (2001) observed that ‘ . . . native whey proteins, from whey protein concentrate (WPC) for example, tend to aggregate when heated in acidic conditions in the presence of casein and this can lead to grittiness in the finished products: this is probably due to the strong interaction between β-lactoglobulin and κ-casein. The formation of firm aggregated protein particles does not occur to the same extent in the continuous process primarily because the denaturation step occurs at a higher pH (e.g. 6.8-7.0)’. Modler & Emmons describe a continuous process for the production of ricotta and Queso Blanco cheese using whey or a mixture of whey and milk. Up to 5% slim milk powder may be added to the mixture. The thermal denaturation of the proteins is conducted at a pH range of 6.8-7.0 to minimise protein deposition on the heat exchanger surfaces. After heat treatment, the mixture is acidified to pH 5-45.6 and allowed to coagulate while still hot before draining and packing.

The Modler & Emmons process is directed towards a continuous process using whey or mixtures of whey and milk that may be fortified with skim milk powder to produce ricotta and they speculate that it has the ‘potential to produce casein, Paneer and Queso Blanco’. Their process requires a curd draining step and does not produce processed cheese directly, if at all. The Modler & Emmons process does not use melting salts and related agents to sequester calcium.

Modler & Emmons made no attempt to vary the cooking pH in any way (beyond the range pH 6.8-7.0) and did not discover that it was possible to vary the texture of cheese-like products over a wide range by selecting combinations of casein to whey protein, pH and cooking conditions. They did not teach of a method capable of producing process cheese.

In WO 02/096209, Renault et al. disclose a process for preparing a cheese base using a two-stage acidification process. The pH is reduced initially by fermentation to 5.6-5.9 and then by direct acid addition to pH 5.2-5.5. The objective of this treatment is to manipulate the product calcium concentration. This process does not attempt (or suggest) to use pH as a means of manipulating the behaviour of whey proteins.

It is an object of the present invention to provide an improved method allowing texture manipulation of dairy products or at least to provide the public with a useful choice.

### DISCLOSURE OF THE INVENTION

In one aspect the invention provides a process for preparing a cheese, a cheese-like product, a yoghurt or a dairy dessert without removing whey comprising:
(a) providing a dairy starting material comprising casein and a quantity of undenatured whey protein;
(b) adjusting the pH, if required, to a pre-selected point in the range 5.0-8.0;
(c) subjecting the material with the desired pH to a cooking step;
(d) adjusting the pH of the cooked product to 4.5-7.5;
(e) processing and/or packing the pH 4.5-7.5 product to form the final product.

Preferably the product is a cheese or cheese-like product.

The dairy starting material may take the form of any type of dairy product containing both casein and whey proteins. Suitable materials for use as the starting product include cheese, skim milk, whole milk, milk protein concentrates and mixtures and any of these. Also suitable are mixtures of a casein source and a whey protein source. For example a mixture of whey protein concentrate and casein.

The ratio of whey protein to casein may be varied within the range of 0.05-3, preferably 0.1-0.75.

The preferred casein concentration is in the range 1-30% (w/w), more preferably 3-20% (w/w). Concentrations in the range 5-15% (w/w) are particularly preferred.

In a preferred embodiment, the invention provides a process for preparing a cheese, a cheese-like product, a yoghurt or a dairy dessert comprising:
(a) providing a dairy starting material comprising casein and a quantity of whey protein;
(b) adjusting the pH, if required, to a preselected point in the range 5.0-8.0;
(c) subjecting the material with the desired pH to a cooking step;
(d) adjusting the pH of the cooked product to 4.5-7.5 while liquid;
(e) placing the pH 4.5-7.5 product into packaging while still liquid; and
(f) providing conditions which allow the packaged product to set.

The term “cheese-like product” is a product which on being consumed by consumer imparts the sensation of consuming cheese. The products of the process include processed cheese and processed cheese spread, cottage cheese and petit suisse. Particularly preferred products include processed cheese and processed cheese spread.

The term “comprising” means “consisting of” or “including”. The processes of the invention may have additional steps and ingredients. For example salt, flavouring, colouring etc may be added.

The inventors have discovered that the texture of cheese, cheese-like products and related products can be varied over a surprisingly wide range by varying the casein to whey protein ratio while controlling the cooling pH in the range 5.0 to 8.0 preferably 5.8-7.5, more preferably 6.0-7.0, most preferably 6.3-7.0. Once the controlled interaction of the proteins has occurred during the cooking period, the final product pH may be attained by adding acid (or alkali) to achieve typically a pH of 4.5-7.5 preferably 5.0-6.3, more preferably 5.0-6.0. The range of product textures may be further varied using this controlled pH-cooking regime, by varying the fat or edible oil content, the heat treatment and the shear conditions. In one preferred embodiment the cooking pH is 6.0-7.0 preferably 6.3-7.0 and the pH is adjusted to 5.0-6.3 preferably 5.0-6.0 after cooking.

Any source of casein may be used—including but not limited to casein, fresh casein curd, young cheese and milk protein concentrate powders (MPC) (retentate powders) or fresh retentate (including modified retentates and retentate powders). Ingredients containing casein that have been pre-treated with an agent to produce para κ-casein are preferred. Preferred fats are milkfat, butter and butter oil (anhydrous milkfat). Any ratio of fat to protein as desired may be used but ratios between zero and 200% are preferred.

Similarly, a wide range of un-denatured whey protein sources may be used depending on the desired lactose and mineral concentrations in the finished product. Dried whey protein concentrates or concentrated whey protein retentates may be used.

The process may be conducted using a mixture of fresh dairy ingredients in the liquid state and optionally fortified with the addition of dry ingredients containing either casein or whey protein containing powders.

Where the process is required to be independent of a milk or whey supply, dry ingredients may be used and preferred sources of such dry ingredients are casein or MPC and whey protein concentrates.

Preferred dry ingredients are blends of casein and whey protein containing powders, or MPC and whey protein containing powders. The casein rich powder and the whey protein rich powders may be pre-blended in a preferred ratio. Alternatively, the casein and whey protein containing powders may be combined at the point of filling the cooking device.

In another aspect, a mixture of wet and dry starting materials may be used.

Preferred cooking temperatures are in the range 50° C. and up to the boiling point of the mixture. The preferred cooking time varies according to temperature used and the nature of the starting material. Generally times in the range 1 second to 30 minutes are used. Preferred cooking times may be chosen on the basis that they are times sufficient for modification of the casein whey interaction. Casein whey interactions provided by the cooking step provide increased strength of the texture of products produced from the casein whey mixture relative to uncooked controls or controls cooked at a pH of approximately 5.7.

The mixture of casein and whey protein, and any fat, is cooked with an initial pH (cooking pH) in the range pH 5.0 to 8.0. Any suitable agent may be used to attain the cooking pH. Preferably the pH adjustment either before or after the cooking step is carried out by direct addition of an alkali or acidulant. Preferred agents may be selected as allowed by Codex Alimentarius Standard 221-2001 (Codex group standard for unripened cheese including fresh cheese). This may be found at http://www.codexalimentarius.net/standard_list.asp or its updates.

In a preferred embodiment, suitable monovalent cationic salts of phosphate and citrate (widely known as melting salts) may be used in conjunction with the alkali or acid. In another aspect, some of the monovalent cationic salts of phosphate and citrate added may substitute for some of the alkali or acid required. Preferred salts are widely known as melting salts and a preferred alkali is sodium hydroxide, and a preferred acids are lactic acid or citric acid or a mixture of the two.

Once the initial cooking step has been concluded, the acidity of the mixture may be increased further to the final desired level by the addition of suitable food-grade acid. Preferred acids are lactic acid, an acid precursor such as glucono-delta-lactone (GDL), citric acid, and acetic acid, or the pH may be manipulated by the addition of melting salts. Any suitable ingredients such as, but not limited to, flavourings, colouring, common salt and water may also be added.

A consequence of the invention is that a wide range of ‘all dairy’ cheese products can be made with desired textures and good flavours but at lower cost. The manufacture of processed cheese and processed cheese spread are preferred products. For some products such as cream cheese, traditional product texture characteristics such as firmness can be attained at an overall reduction in protein content. This offers the consumer the prospect of a more competitive product. Alternatively, increasing the whey protein to casein ratio may make a firmer product having the same overall protein content.

### BRIEF DESCRIPTION OF THE DRAWINGS

Preferred embodiments of the invention will now be described with reference to the accompanying drawings.

FIG. 1 is a flow diagram showing a preferred embodiment.

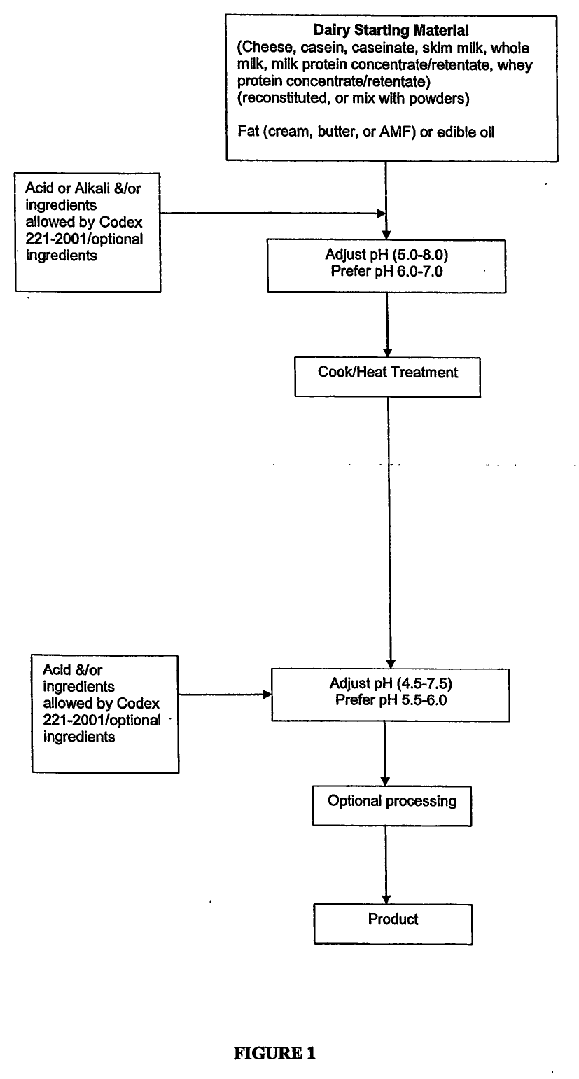

FIG. 2 shows a graph of gel firmness (Elastic Modulus G′ (Pa) against cooking pH (rennet casein squares, cheese triangles)

FIG. 3 shows a surface plot of G vs pH and Hold.

### EXAMPLES

The following examples further illustrate practice of the invention.

### Example 1

### A Gel Formulation Made from Cheese with the Texture of the Product being Varied Depending on the Cook pH

| Ingredient | Weight (g) |
|---|---|
| Butter | 119.40 |
| Cheddar Cheese | 216.29 |
| WPC (ALACEN 392) | 14.11 |
| Water | 223.29 (includes 7 g for evaporation) |
| Sodium chloride | 2.51 |
| Tri-sodium citrate | 11.59 |
| Citric acid | 1.332 |
| Total weight | 581.51 |

Preparation of Gel Samples—Generic Procedure Using Cheese
Sample 1

Equipment

The processed cheeses were prepared using a 2 L capacity Vorwerk Thermomix™ 21 blender cooker (Vorwerk & Co. Thermomix GmbH, Wuppertal, Germany).

Ingredients and Preparation

14.11 g WPC (ALACEN 392, NZMP, Wellington, New Zealand) was dispersed in 61.88 g water and allowed to hydrate overnight at 4° C.

Butter (NZMP, Wellington, New Zealand) was heated for 1 min in the blender-cooker with the temperature setting at 100 and impellor speed setting 1 (100 rpm). This brought the melted butter temperature to around 60° C.).

Cheddar cheese [matured for >12 months] (NZMP, Wellington, New Zealand), tri-sodium citrate (BHD Laboratory Supplies, Poole, England), sodium chloride (BHD Laboratory Supplies, Poole), water (141.7 mL), the hydrated WPC and 4.2 mL of 3M sodium hydroxide (BHD Laboratory Supplies, Poole) were added to the melted butter. This provided a mixture for the cooking stage with a pH of 6.7 [denoted the ‘cook pH’ ].

The mixture was cooked at a temperature setting of 90 for 2 min at speed 4 (2000 rpm), after which the temperature was lowered to a temperature setting of 80 for 7 min. At the end of each minute, the speed was set to “Turbo” (12,000 rpm) for 3 s to thoroughly mix the emulsion as well as to prevent burning and sticking of the emulsion to the wall of the cooker. Once cooked, the final pH of the product was attained by the addition of 1.332 g of citric acid (BHD Laboratory Supplies, Poole) dissolved in 20 g of water, together with 2.3 mL of 3 M hydrochlorid acid, at the end of the 7^{th} minute. The final temperature of the processed cheese melt was 82° C. At the end of the 9^{th} minute, the molten processed cheese was poured into plastic screwed cap containers, inverted then stored at 4° C. The final pH of the processed cheese was about 5.7 at 20° C.

Varying the Cook pH and Adjusting Final pH Back to 5.7

The pH of the gel samples was measured with a Schott Geräte N 48EE “stab” electrode (Schott Geräte GmbH, Hafheim, Germany) and a Radiometer pH82 meter (Radiometer, Copenhagen, Denmark).

The above recipe and procedure was repeated a further three times except the cook pH was adjusted to pH 6.3, 7.0 and 7.4 for the three experiments. The details of the preparation of samples 2-4 are summarised in Table 1.

TABLE 1
pH adjustment details for the preparation of the gel samples

| | | mL 3 M NaOH | mL of 3 M HCl added to attain |
|---|---|---|---|
| | | added to attain | final product pH of 5.7 (together |
| Sample | Cook pH | cook pH | with 1.332 g citric acid) |
| 2 | 6.3 | 1.8 | 0.1 |
| 3 | 7.0 | 6.0 | 4.0 |
| 4 | 7.4 | 8.4 | 6.2 |

Composition of the Gel Samples

The product had 53.8% moisture, 29.5% fat, 11.2% protein and balance 5.5% salts etc.

Method of Measurement of Elastic Modulus, G′

The elastic modulus, G′ was obtained at 0.1 Hz using a Carri-Med CSL100 rheometer (TA Instruments—Waters LLC, New Castle, USA) at 20° C. as described by S. K. Lee & H. Klostermeyer (2001). A description of elastic modulus is detailed in Ferry (1980). Gel firmness observations at the same pH were replicate determinations taken from the same gel sample.

Product Texture

The viscosity of the gels at 20° C. varied from a ‘runny’ spread consistency to a firmish gel. Table 2 summarises the texture measurements.

TABLE 2
Texture (G′) of the gel samples at 20° C. and 0.1 Hz

| Gel Sample | Cook pH | G′ with replicate determinations (Pa) |
|---|---|---|
| 1 | 6.3 | 42.6, 64.3, 47.9 |
| 2 | 6.7 | 395.2, 520.3, 433.9 |
| 3 | 7.0 | 668.1, 821.2, 647.1, 658.4 |
| 4 | 7.4 | 414.4, 355.4 |

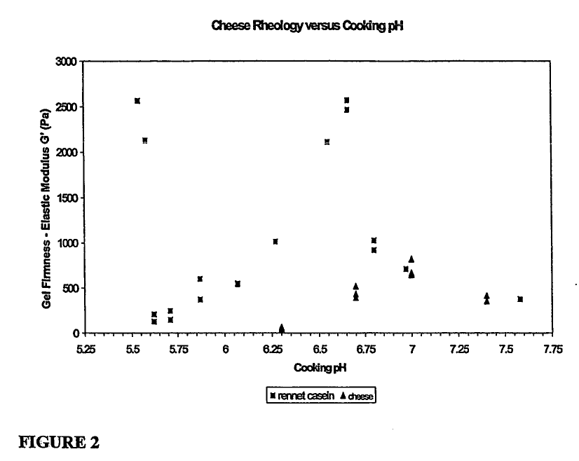

The texture results are plotted in FIG. 2.

### Example 2

### Gel Formulations Using Rennet Casein with Texture Varied According to Cook pH

| Ingredient | Weight (g) | |
|---|---|---|
| Sunflower oil | 192 | |
| Rennet casein | 55.08 | |
| WPC (ALACEN 392) | 15.36 | |
| Water | 306.64 | (includes allowance of 11 g |
| | | for evaporation) |
| Sodium chloride | 6.0 | |
| Tri-sodium citrate | 11.43 | |
| Citric acid | 3.57 | |
| Total weight | 590.08 | |

Preparation of Gel Samples—Generic Procedure Using Rennet Casein
Sample 1

Equipment

The equipment used was the same as for the cheese based gels.

Ingredients and Preparation

Rennet casein 55.08 g, (ALAREN 799, 90 mesh, NZMP, Wellington, New Zealand) was hydrated in a solution of 11.43 g tri-sodium citrate (BHD Laboratory Supplies, Poole, England), 1.66 g citric acid (BHD Laboratory Supplies, Poole, England), 6 g sodium chloride (BHD Laboratory Supplies, Poole, England) and 170 g water. (The whey protein/casein ratio was 0.28.) The hydration of the mixture occurred overnight at 4° C.

WPC (ALACEN 392, NZMP, Wellington, New Zealand) was dispersed in 67.64 g water and stored at 4° C. overnight.

192 g sunflower oil (Sunfield Oils, Tasti Products Ltd., Auckland, New Zealand) was heated in the cooker for 1 min with the temperature setting at 100 and speed setting 1 (100 rpm).

This brought the oil temperature to around 60° C.

The hydrated rennet casein, WPC and water (48.7 g) were added to the sunflower oil. The hydrated mixture had a [cook] pH of 6.7.

The mixture was cooked at a temperature setting of 90 for 2 min at speed 4 (2000 rpm), after which the temperature was lowered to a temperature setting of 80 for 7 min. At the end of each minute, the speed was set to “Turbo” (12,000 rpm) for 3 s to thoroughly mix the emulsion as well as to prevent burning and sticking of the emulsion to the wall of the cooker.

The pH of the final product was obtained by the addition of 1.91 g of citric acid (dissolved in 20 g of cold water) at the end of the 7^{th} min. The temperature of the mixture during the final 2 minutes was 82° C. At the end of the 9^{th} min the molten processed cheese was poured into plastic screwed cap containers, inverted then stored at 4° C. After allowing to cool to room temperature, the final pH of the gel was about 5.7, at 20° C.

Composition of the Processed Cheese Product

The product had a composition of 52.1% moisture, 33.2% fat, 10% protein and remainder 4.7% minerals and other.

Varying the Cook pH and Adjusting Final pH Back to 5.7

For samples with a cook pH>5.7, the cook pH was varied by altering the proportion of the citric acid added for the cooking phase and the balance added post cooking to attain a constant final product pH and composition. The total citric acid added was 3.57 g.

For samples with a cooking pH <5.7, the cooking pH was varied by altering the proportion of the tri-sodium citrate added for the cooking phase and the balance to attain the final product pH. The total tri-sodium citrate added was 11.43 g.

TABLE 3
pH adjustment details for the preparation of the gel samples

| | | | Citric acid | Balance of reagent | |
|---|---|---|---|---|---|
| | | tri-sodium citrate | (g) added | added post cooking to | |
| | Cook | (g) added to attain | to attain | attain pH of 5.7 | |
| Sample | pH | cook pH | cook pH | Na₃ citrate/citric acid | |
| 1 | 5.54 | 6.24 | 3.57 | 5.19 | 0 |
| 2 | 5.58 | 7.44 | 3.57 | 3.99 | 0 |
| 3 | 5.62 | 8.64 | 3.57 | 2.79 | 0 |
| 4 | 5.71 | 11.43 | 3.57 | 0 | 0 |
| 5 | 5.87 | 11.43 | 3.20 | 0 | 0.37 |
| 6 | 6.07 | 11.43 | 2.80 | 0 | 0.77 |
| 7 | 6.27 | 11.43 | 2.42 | 0 | 1.15 |
| 8 | 6.55 | 11.43 | 1.85 | 0 | 1.72 |
| 9 | 6.66 | 11.43 | 1.66 | 0 | 1.91 |
| 10 | 6.8 | 11.43 | 1.47 | 0 | 2.10 |
| 11 | 6.97 | 11.43 | 1.09 | 0 | 2.48 |
| 12 | 7.6 | 11.43 | 0 | 0 | 3.57 |

Physical Properties of the Processed Cheese

The rheology was examined using the same instrument and procedure as above and the textures are summarised in Table 4. The gels varied in texture from a soft pourable spread to that of a stiff gel.

TABLE 4
Texture (G′) of the gel samples at 20° C. and 0.1 Hz

| Gel Sample | Cook pH | G′ with replicate determinations (Pa) |
|---|---|---|
| 1 | 5.54 | 2564 |
| 2 | 5.58 | 2129 |
| 3 | 5.62 | 127, 210.2 |
| 4 | 5.71 | 247.7, 148.2 |
| 5 | 5.87 | 600.1, 372.3 |
| 6 | 6.07 | 549.4, 542.3 |
| 7 | 6.27 | 1014 |
| 8 | 6.55 | 2112 |
| 9 | 6.66 | 2571, 2466 |
| 10 | 6.8 | 1029, 921.4 |
| 11 | 6.97 | 711.9 |
| 12 | 7.6 | 376.3 |

The texture results are plotted in FIG. 2.

In a further illustration of the versatility of the cooking pH technique, a product with the textural characteristics of cream cheese was prepared without homogenisation—a process widely used in the commercial production of cream cheese.

### Example 3

### Preparation of a Cream Cheese-Like Product

Preparation of a Cream Cheese Using Vorwerk Cooker

| Ingredient | Weight (g) | |
|---|---|---|
| Anhydrous milk fat (AMF) | 193.185 | |
| Rennet casein | 45.792 | |
| WPC (ALACEN 392) | 25.44 | |
| Water | 301.175 | (includes allowance of 11 g |
| | | for evaporation) |
| Sodium chloride | 6.36 | |
| Tri-sodium citrate | 12.879 | |
| Citric acid | 5.872 | |
| Total | 590.703 | |

Gel Preparation

The model cream cheese was prepared using a 2L capacity Vorwerk Thermomix™ 21 blender cooker (Vorwerk Australia Pty. Ltd., Granville, N.S.W., Australia).

The rennet casein (ALAREN 799, 90 mesh, NZMP, Wellington, New Zealand) was hydrated with sodium chloride, tri-sodium citrate (Jungbunzlauer GmbH, Perhofen, Austria) and 3.0 g citric acid (Jungbunzlauer GmbH, Perhofen, Austria) and 100 g of water and held overnight at 4° C. The WPC (ALACEN 392, NZMP Wellington, New Zealand) was hydrated in 60 g of water for half an hour at room temperature.

Frozen anhydrous milk fat, NZMP, Wellington, New Zealand after thawing at room temperature was heated for 1 min at temperature setting of 100 and speed 1 (100 rpm).

The hydrated rennet casein, hydrated WPC and water (141.2 g) were added to the AMF. The mixture was cooked at a temperature setting of 90 for 2 min at speed setting 5 (3500 rpm), after which the temperature was lowered to a temperature setting of 80 for 7 min at speed 5. At the end of each minute, the speed was set to “Turbo” (12,000 rpm) for 3 s to thoroughly mix the emulsion as well as to prevent burning and sticking of the emulsion to the wall of the cooker. (The mixture had a whey protein/casein ratio of 0.56.) The cooking pH was about 5.7.

The pH of the final product was obtained by the addition of 2.861 g of citric acid at the end of the 8^{th} min. The final temperature of the processed cheese melt was 82° C. At the end of the 9^{th} min, the molten product was poured into plastic screwed cap containers, inverted then stored at 4° C. The final pH of the product was 4.98.

Composition of Gel

The cream cheese gel had a composition of 51.0% water, 33.6% fat, 10.1% protein, 5.6% salts and minerals (balance).

Physical Properties of the Processed Cheese

The cream cheese like composite gel had an elastic modulus, G′ of between 42.1 kPa to 54.4 kPa measured at 0.1 Hz at 20° C.

### Example 4

### Gel Formation Using Rennet Casein and Pre-Denatured Whey Proteins

| Ingredient | Weight (g) | |
|---|---|---|
| Sunflower oil | 192 | |
| Rennet casein | 55.08 | |
| WPC (ALACEN 392) solution | 83.0 | (containing 15% |
| | | whey protein) |
| Water | 239 | (includes allowance of 11 g |
| | | for evaporation) |
| Sodium chloride | 6.0 | |
| Tri-sodium citrate | 11.43 | |
| Citric acid | 3.57 | |
| Total | 590.08 | |

Gel Preparation

The model processed cheeses were prepared using a 2L capacity Vorwerk Thermomix™ 21 blender cooker (Vorwerk & Co. Thermomix GmbH, Wuppertal, Germany).

Rennet casein (55.08 g, ALAREN 799, 90 mesh, NZMP, Wellington, New Zealand) was hydrated in a salt solution of 11.43 g tri-sodium citrate (BHD Laboratory Supplies, Poole, England), 3.57 g citric acid (BHD Laboratory Supplies, Poole, England), 6 g sodium chloride (BHD Laboratory Supplies, Poole) and 170 g water. The mixture was hydrated overnight at 4° C. This provided a cook pH of 5.7.

Denatured WPC of 15 g protein in 100 g water (ALACEN 392, NZMP, Wellington, New Zealand) was prepared using the method of Huss & Spiegel (2000) of controlled temperature, time and limited shear. The hydrated rennet casein, denatured WPC and water (48.7 g) were added to the sunflower oil. The mixture was cooked at a temperature setting of 90 for 2 min at speed setting 4 (2000 rpm), after which the temperature was lowered to a temperature setting of 80 for 7 min. At the end of each minute, the speed was set to “Turbo” (12,000 rpm) for 3 s to thoroughly mix the emulsion as well as to prevent burning and sticking of the emulsion to the wall of the cooker. 20 g of water was added at the end of the 7^{th} min. The final temperature of the processed cheese melt was 85° C. At the end of the 9^{th} min the molten processed cheese was poured into plastic screwed cap containers, inverted then stored at 4° C. The final pH of the processed cheese was 5.7.

Composition of the Composite Gel

The processed cheese had 52.1% moisture, 33.2% fat, 10% protein and remainder 4.7% minerals and others.

Physical Properties of the Processed Cheese

The processed cheese cooked was a soft and “runny” emulsion which flowed without support. Its elastic modulus, G′ was 64.5 Pa measured at 0.1 Hz at 20° C. and should be compared with the elastic modulus shown in Table 4 of a sample cooked at pH 5.71 using un-denatured whey protein. Comparison between these two samples demonstrated that un-denatured whey protein present during the cooking stage is required to increase the elastic modulus of the resulting gel.

### Example 5

### Gel Formation Using Rennet Casein Alone (No Whey Protein)

| Ingredient | Weight (g) | |
|---|---|---|
| Sunflower oil | 192 | |
| Rennet casein | 69.5 | |
| Water | 304.8 | (includes allowance of |
| | | 11 g for evaporation) |
| Sodium chloride | 6.0 | |
| Tri-sodium citrate | 11.17 | |
| Citric acid | 3.83 | |
| Total | 587.3 | |

Gel Preparation

The model processed cheeses were prepared using a 2L capacity Vorwerk Thermomix™ 21 blender cooker (Vorwerk & Co. Thermomix GmbH, Wuppertal, Germany).

Rennet casein (ALAREN 799, 90 mesh, NZMP, Wellington, New Zealand) was hydrated in a salt solution of 11.17 g tri-sodium citrate (BHD Laboratory Supplies, Poole, England), 3.83 g citric acid (BHD Laboratory Supplies, Poole, England), 6 g sodium chloride (BHD Laboratory Supplies, Poole) and 170 g water. The mixture was hydrated overnight at 4° C. This provides a cooking pH of 5.7.

The hydrated rennet casein and 114.8 mL water were added to the sunflower oil. The mixture was cooked at a temperature setting of 90 for 2 min at speed 4 (2000 rpm), after which the temperature was lowered to a temperature setting of 80 for 7 min. At the end of each minute, the speed was set to “Turbo” (12,000 rpm) for 3 s to thoroughly mix the emulsion as well as to prevent burning and sticking of the emulsion to the wall of the cooker. 20 mL water was added at the end of the 7^{th} min.

The final temperature of the processed cheese melt was 82° C. At the end of the 9^{th} min, the molten processed cheese was poured into plastic screwed cap containers, inverted then stored at 4° C. The final pH of the processed cheese was about 5.7.

Composition of the Composite Gel

The processed cheese had 52.0% moisture, 33.2% fat, 10.1% protein and remainder 4.6% minerals and others.

Physical Properties of the Processed Cheese

The processed cheese cooked was a soft emulsion. Its elastic modulus, G′ was 113.5, 122.9 and 176.9 Pa measured at 0.1 Hz at 20° C.

In a similar experiment, to demonstrate that varying the cook pH of casein alone does not contribute significantly to changes in gel hardness, 11.172 g tri-sodium citrate, 6 g salt, 1.118 g citric acid were used to hydrate the rennet casein overnight and then cooked as above. Cooking pH of 6.7. At the end of the run, 2.711 g citric acid dissolved in 20 mL water was added. The gel has G′ of 148.5, 160.4, 164.7 and 178.9 Pa at 20° C. at 0.1 Hz. Comparison of the elastic modulus between the results cooked at pH 5.7 and 6.7 show that with casein alone there was no material difference in gel firmness. This stands in contrast to the results in Table 4 when the cooking was conducted with un-denatured whey protein present.

Composition of the Composite Gel

The processed cheese had 52.0% moisture, 33.2% fat, 10.1% protein and remainder 4.6% minerals and others.

### Example 6

### Gel Formation Using Mk Protein Concentrate (MPC 85)

Two samples were prepared using an ingredient where the casein and un-denatured whey protein were already provided (MPC) and no separate addition of whey protein concentrate was required.

| Ingredient | Weight (g) | |
|---|---|---|
| Sunflower oil | 192 | |
| MPC 85 | 70.7 | |
| Water | 312.5 | (includes allowance of |
| | | 11 g for evaporation) |
| Sodium chloride | 6.0 | |
| Trisodium citrate | 11.32 | |
| Citric acid | 3.68 | |
| Total | 596.2 | |

Gel Preparation

The model processed cheeses were prepared using a 2L capacity Vorwerk Thermomix™ 21 blender cooker (Vorwerk & Co. Thermomix GmbH, Wuppertal, Germany).

MPC 85 (ALAPLEX 4850, N.Z. Milk Protein Concentrate, NZMP, Rellingen, Germany) was hydrated in a salt solution of 11.32 g tri-sodium citrate (BHD Laboratory Supplies, Poole, England), 3.68 g citric acid (13HD Laboratory Supplies, Poole, England), 6 g sodium chloride (BHD Laboratory Supplies, Poole) and 200 g water. The mixture was hydrated overnight at 4° C. This provides a cook pH of 5.7.

The hydrated MPC 85 and 92.5 mL water were added to the sunflower oil. The mixture was cooked at a temperature setting of 90 for 2 min at speed setting 4 (2000 rpm), after which the temperature was lowered to a setting of 80 for 7 min. At the end of each minute, the speed was set to “Turbo” (12,000 rpm) for 3 s to thoroughly mix the emulsion as well as to prevent burning and sticking of the emulsion to the wall of the cooker. 20 mL water was added at the end of the 7^{th} min. The final temperature of the processed cheese melt was 82° C. At the end of the 9^{th} min, the molten processed cheese was poured into plastic screwed cap containers, inverted then stored at 4° C. The final pH of the processed cheese was about 5.7.

Composition of the Composite Gel

The processed cheese had 52.0% moisture, 33.0% fat, 10.0% protein and remainder 4.7% minerals and others.

Physical Properties of the Processed Cheese

The processed cheese cooked was a soft and “runny” emulsion which flowed without support.

Its elastic modulus, G′ was 65.6 Pa measured at 0.1 Hz at 20° C.

The above was repeated method as above but the salt additions were adjusted to give a cook pH6.7.

MPC 85 was hydrated in salt solution (11.32 g tri-sodium citrate (BHD Laboratory Supplies, Poole, England), 1.07 g citric acid (BHD Laboratory Supplies, Poole, England), 6 g sodium chloride (BHD Laboratory Supplies, Poole) and 200 g water). The mixture was hydrated overnight at 4° C. This provided a cook pH of 6.7.

At end of 7^{th} min, 2.61 g citric acid dissolved in 20 mL of water was added. The composition of the samples was as noted above.

Physical Properties of the Processed Cheese

The processed cheese cooked was a thick emulsion of elastic modulus, G′ of 1118 Pa measured at 0.1 Hz at 20° C. This gel, prepared at a cook pH close to the maximum of the curve disclosed in FIG. 2, had an elastic modulus almost 20 times than that of the sample cooked at pH 5.7 (close to the minimum in the curve shown in FIG. 2.) This comparison demonstrated that the whey protein (in an un-denatured form) can be applied along with the casein and does not have to be added as a separate ingredient to the process.

### Example 7

### Experiments Examining the Effect of Varying Both the Cooking pH and Cooking Time

Equipment

The cheese spread samples were prepared using a 2L capacity Vorwerk Thermomix™ 21 blender cooker (Vorwerk Australia Pty. Ltd., Granville, N.S.W., Australia).

Formulation for Spread Samples

The samples were prepared using the quantities of ingredients summarised below.

| Ingredient | Weight (g) | |
|---|---|---|
| Sunflower oil | 191.36 | |
| Rennet casein (ALAREN 799, 90 mesh) | 61.11 | |
| WPC (ALACEN 392) | 15.80 | |
| Water | 296.50 | (includes allowance of |
| | | 7.75 g for evaporation) |
| Sodium chloride | 6.30 | |
| Tri-sodium citrate | 12.311 | |
| Citric acid | 3.439 | |
| Total | 586.83 | |

Gel Preparation

To prepare a cooking pH 5.7 sample, rennet casein (ALAREN 799, 90 mesh, NZMP, Wellington, New Zealand) was hydrated in salt solution (12.311 g tri-sodium citrate (Jungbunzlauer GmbH, Perhofen, Austria), 3.439 g citric acid (Jungbunzlauer GmbH, Perhofen, Austria), 6.3 g sodium chloride (Pacific Salt, Christchurch, New Zealand) and 170 g water). The mixture was hydrated overnight at 4° C. To provide the various cooking pHs of the samples produced in Table 7, the amounts of tri-sodium citrate and citric acid were adjusted according to the quantities in Table 5 for the selected experiment.

Sunflower oil (Sunfield Oils, Tasti Products Ltd, Auckland, New Zealand) was heated for 1 minute at a temperature setting of 100 and speed setting 1 (this brought the temperature of the oil to 60° C.).

The hydrated rennet casein, WPC (dispersed in 50 g water) and water (56.5 g) were added to the sunflower oil. The mixture was cooked at a temperature setting of 90 for 2 minutes at speed 4 (2000 rpm), after which the temperature was lowered to a temperature setting of 80 for a set cooking time (see Table 6). At the end of each minute, the speed was set to “Turbo” (12,000 rpm) for 3 s to thoroughly mix the emulsion as well as to prevent burning and sticking of the emulsion to the wall of the cooker. 20 g of water and 3.161 g TSC was added at the end of the cooking time and held for a further 2 minutes at the same temperature and speed. (To attain the final product pH for the other samples, the quantities of TSC or CA from Table 5 were added in substitution of the 3.161 g TSC to give the required final pH in Table 7.) The hot processed cheese spread was transferred into plastic screwed cap containers, inverted then stored at 4° C. The final pH of the processed cheese spread was about 5.75.

Composition of the Composite Gel

The processed cheese spread had a composition of 51.0% moisture, 33.2% fat, 11% protein and remainder 4.8% minerals and others.

TABLE 5
Amounts of tri-sodium citrate (TSC) and citric acid (CA) required to
achieved different cooking pH (columns 2 and 3) and to achieve final
product pH of 5.75 (columns 4 and 5)

| | TSC added | CA added | TSC at the end | CA at the |
|---|---|---|---|---|
| | at casein | at casein | of holding time | end of holding |
| Cook pH | hydration (g) | hydration (g) | (g) | time (g) |
| 5.70 | 9.151 | 3.439 | 3.161 | 0 |
| 6.075 | 12.311 | 2.573 | 0 | 0.866 |
| 6.45 | 12.311 | 1.187 | 0 | 2.252 |
| 6.825 | 12.311 | 0.551 | 0 | 2.878 |
| 7.2 | 12.311 | 0.053 | 0 | 3.386 |

TABLE 6
Randomised factorial design for selected pH and holding times

| Cooking time | |
|---|---|
| (minutes) | Cooking pH |
| 4 | 5.7 |
| 4 | 6.075 |
| 0 | 5.7 |
| 8 | 5.7 |
| 4 | 6.45 |
| 6 | 6.45 |
| 8 | 7.2 |
| 8 | 5.7 |
| 4 | 7.2 |
| 0 | 7.2 |
| 8 | 7.2 |
| 4 | 6.825 |
| 0 | 7.2 |

Results (in Randomised Trial Order)

The elastic modulus, G′ of the samples was obtained using the texture analyser method described above and summarised in Table 7.

TABLE 7
Texture results of varying cooking time and cooking pH

| | | | | Texture (G′) |
|---|---|---|---|---|
| | | | | Pa |
| Cooking | | Final | | (Replicate |
| time | Cooking | product | Final product | determination from |
| (minutes) | pH | pH | moisture (%) | same sample) |
| 4 | 5.7 | 5.74 | 51.03 | 643.6/668.8 |
| 4 | 6.075 | 5.73 | 50.9 | 704.5/717.6 |
| 0 | 5.7 | 5.74 | 51.29 | 290.2/302.2 |
| 8 | 5.7 | 5.75 | 50.88 | 1363/1357 |
| 4 | 6.45 | 5.73 | 51.37 | 852.6/858.0 |
| 6 | 6.45 | 5.75 | 51.08 | 2549/2726 |
| 8 | 7.2 | 5.74 | 51.09 | 1125/1125 |
| 8 | 5.7 | 5.73 | 50.93 | 1143/1010 |
| 4 | 7.2 | 5.75 | 51.25 | 929.8/869.6 |
| 0 | 7.2 | 5.76 | 51.37 | 290.7/264.2 |
| 8 | 7.2 | 5.76 | 50.84 | 1427/1484 |
| 4 | 6.825 | 5.74 | 51.08 | 2658/2712 |
| 0 | 7.2 | 5.76 | 51.54 | 218.0/235.5 |
| 4 | 6.45 | 5.74 | 51.16 | 1363/1135 |
| 2 | 6.45 | 5.74 | 51.20 | 441.7/461.7 |
| 0 | 5.7 | 5.74 | 51.14 | 249.8/223.6 |

Using a quadratic regression function, Minitab analysis of the sample texture (G′) results showed that holding time was significant at the P=0.01 level and pH at the P=0.05 level.

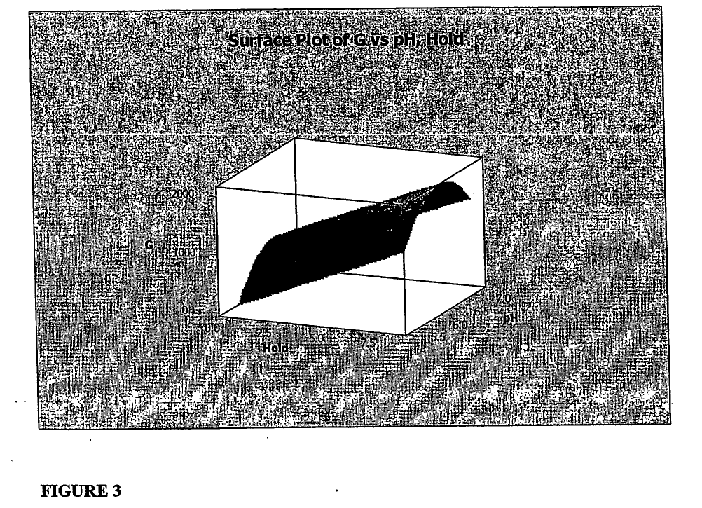

Product firmness increased with increasing initial cooking time over the range examined (0-8 minutes) and the optimum initial cook pH was found to occur between 6.3<pH <6.9. The results in Table 7 corroborated the earlier results and demonstrated that at a given cook time, the samples cooked at a pH of about 6.8 resulted in a firmness significantly higher than the controls that were cooked conventionally at a pH of about 5.75. This is shown in FIG. 3.

The above examples are illustrations of the practice of the invention. It will be appreciated by those skilled in the art that the invention to be carried out numerous modifications and variations. For example the casein/whey protein ratio, the cooking temperature, the cooking pH and the acid used to alter the pH may all be varied.

1. A process for preparing a cheese, a cheese-like product, a yoghurt or a dairy dessert without removing whey comprising:
(a) providing a dairy starting material comprising casein and a quantity of undenatured whey protein;
(b) adjusting the pH, if required, to a preselected point in the range 5.0-8.0;
(c) subjecting the material with the desired pH to a cooking step;
(d) adjusting the pH of the cooked product to 4.5-7.5;
(e) processing and/or packing the pH 4.5-7.5 product to form the final product.

2. A process as claimed in claim 1 wherein the product is a cheese or cheese-like product.

3. A process as claimed in claim 1 where the diary starting material is selected from cheese, skim milk, whole milk, milk protein concentrates, retenates, casein, caseinate, whey protein and mixtures of any of these.

4. A process as claimed in claim 1 wherein the ratio of why protein to casein is within the range of 0.05-0.75.

5. A process as claimed in claim 1 wherein the casein concentration of the starting material is in the range of 1-30% (w/w).

6. A process as claimed in claim 5 wherein the casein concentration of the starting material is 3-20% (w/w).

7. A process as claimed in claim 6 wherein the casein concentration of the starting material is 5-15% (w/w).

8. A process as claimed in claim 1 wherein the pH at the end of step (b) is in the range of 5.8-7.5.

9. A process as claimed in claim 8 wherein the pH at the end of step (b) is in the range of 6.0-7.0.

10. A process as claimed in claim 9 wherein the pH at the end of step (b) is in the range of 6.3-7.0.

11. A process as claimed in claim 1 wherein acid or alkali is added after the cooking step to achieve a pH of 4.5-7.5.

12. A process as claimed in claim 11 wherein acid or alkali is added after the cooking to achieve a pH of 5.0-6.0.

13. A process as claimed in claim 12 wherein acid or alkali is added after the cooking step to achieve a pH of 5.0-6.0.

14. A process as claimed in claim 9 wherein after the cooking step the pH is adjusted to 5.0-6.3.

15. A process as claimed in claim 9 wherein after the cooking step the pH is adjusted to pH 5.0-6.0.

16. A process as claimed in claim 1 wherein the cooking temperature is in the range of 50° C. to up to the boiling point of the mixture.

17. A process as claimed in claim 1 wherein the cooking step is used for 1 second to 30 minutes.

18. A process as claimed in claim 17 wherein the cooking step is used for a time within the range 5 seconds to 15 minutes.

19. A process for preparing a cheese, a cheese-like product, a yoghurt or a dairy dessert comprising:
(a) providing a dairy starting material comprising casein and a quantity of whey protein;
(b) adjusting the pH, if required, to a preselected point in the range 5.0-8.0;
(c) subjecting the material with the desired pH to a cooking step;
(d) adjusting the pH of the cooked product to 4.5-7.5 while liquid;
(e) placing the pH 4.5-7.5 product into packaging while still liquid; and
(f) providing conditions which allow the packaged product to set.

20. (canceled)

21. A process as claimed in claim 1 wherein the product is a cheese.
